(19) United States
(12) Patent Application Publication
(10) Pub. No.: US 2026/0303592 A1
(43) Pub. Date: Oct. 1, 2026

(54) METHOD AND SYSTEM FOR SECURE PASSWORD RESET

(71) Applicant: Sophos Limited, Abingdon Oxfordshire (GB)

(72) Inventors: Sowri Raju BATHINENI, Bangalure (IN); Yogesh Kumar BANSAL, Bangalore (IN); KARTIKEYA, Bangalore (IN)

(73) Assignee: Sophos Limited, Abingdon Oxfordshire (GB)

(21) Appl. No.: 19/297,671

(22) Filed: Aug. 12, 2025

(30) Foreign Application Priority Data
Mar. 29, 2025 (IN) 202511030887

(51) Int. Cl. H04L 9/40

(52) U.S. Cl. CPC H04L 63/0846

(57) ABSTRACT

A central management system can facilitate account recovery for a network device. Prior to account recovery, the network device is registered with the central management system. A user device connects to the central management system over the cloud. The user device selects the network device at the central management system, leading to forming a secure data tunnel between the central management system and the network device. Then, the user device requests a new password from the central management system, which provides a temporary password to the network device. The network device then sends the temporary password as a secure message to the user device, which permits a user to supply a user-selected password. The user device sends the user-selected password back to the network device, which updates user login credentials accordingly. This approach provides for a secure, easy password reset without a factory reset of the network device.

### CROSS-REFERENCE TO RELATED APPLICATIONS

This application claims priority to Indian Patent Application No. 202511030887, entitled, “Method and System For Secure Password Reset,” filed Mar. 29, 2025, which is incorporated herein by reference in its entirety.

### TECHNICAL FIELD

Embodiments relate generally to password management for network devices, and more particularly, to methods, systems, and computer-readable media for secure password reset of network devices using a central management system.

### BACKGROUND

Most cloud-managed and unmanaged network appliances, such as network switches, routers, wireless, and other types of network access points, and firewalls, are shipped with a factory default password to enable recovery in case the administrator forgets an account password. Using the default password for recovery may involve a factory reset, which wipes out all (or most) configuration information and results in downtime. Additionally, since this default password is often provided on a sticker physically affixed to the network device, the password can be easily lost, leaving no way to recover the login credentials. Even if the default password is not lost, a factory reset still necessitates a device reboot, causing downtime.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations of this application relate to methods, systems, and computer-readable media for secure password reset.

According to one aspect, a computer-implemented method is provided. The computer-implemented method can include sending credentials to a central management system to initiate a password reset process for a network device at the central management system, wherein the credentials comprise account credentials associated with a user of the network device and an identifier of the network device; sending a request to the network device to cause the network device to connect to the central management system using a secure data tunnel; receiving an acknowledgement from the central management system that the secure data tunnel is established between the central management system and the network device; receiving a password change request for the network device from a user of a user device; sending a request to the central management system for a new password for the network device to be sent to the network device over the secure data tunnel, wherein the new password is a temporary password; receiving the new password from the network device as a secure message; logging the user of the network device into the network device using the new password, wherein the network device enables the user of the user device to set a user-selected password for the user of the network device; and updating user login credentials of the user of the network device based on the user-selected password, wherein pre-existing user login credentials of the user of the network device are marked invalid.

In some implementations, the identifier of the network device is a serial number of the network device automatically obtained from hardware, firmware, software, or a combination thereof of the network device.

In some implementations, the identifier of the network device is a serial number of the network device that is pre-registered at the central management system.

In some implementations, the network device performs a reboot operation prior to connecting to the central management system using the secure data tunnel, wherein the reboot operation of the network device preserves settings of the network device.

In some implementations, the secure data tunnel is a WebSocket channel.

In some implementations, the new password for the network device is associated with an expiry time, and wherein logging the user of the network device into the network device using the new password is performed prior to the expiry time.

In some implementations the user-selected password is associated with an administrator user account on the network device.

According to one aspect, a computer-implemented method is provided. The computer-implemented method can include registering an identifier of a network device with a central management system; receiving an authentication token from the central management system; forming a secure data tunnel with the central management system using the authentication token; receiving a password change notification from the central management system via the secure data tunnel, wherein the password change notification includes a new password, wherein the new password is a temporary password; sending the new password to a user device in a secure message; receiving a user-selected password for the network device from the user device in a second secure message; and updating user login credentials of the network device based on the user-selected password, wherein the updating includes marking pre-existing user login credentials as invalid.

In some implementations, the identifier of the network device is a serial number of the network device.

In some implementations, the user-selected password is associated with an administrator user account on the network device.

In some implementations, a reboot operation of the network device is performed after a user of the user device sends credentials to the central management system to initiate a password reset process for the network device, and wherein the credentials comprise account credentials associated with a user of the network device and the identifier of the network device.

In some implementations, the settings of the network device are preserved during the reboot operation of the network device.

In some implementations, the reboot operation of the network device is requested via hardware input from a physical button of the network device or from other physical interaction with the network device, via software input, or a combination thereof.

In some implementations, the new password is received over the secure data tunnel directly from the central management system or by a secure pull operation from the central management system.

According to one aspect, a computer-implemented method is provided. The computer-implemented method can include receiving credentials from a user device to initiate a password reset process for a network device, wherein the credentials comprise account credentials associated with a user of the network device and an identifier of the network device; receiving a request from the network device to register the network device, the request comprising the identifier of the network device; receiving a selection of the network device from a user of the user device; sending an authentication token to the network device; forming a secure data tunnel with the network device using the authentication token; sending an acknowledgment to the user device that the network device has connected to a central management system; receiving a request from the user device to reset a password of the network device; sending a password change notification to the network device over the secure data tunnel, wherein the password change notification includes a new password, wherein the new password is a temporary password, the new password is used to update user login credentials of the network device by sending the new password to the user device as a secure message to update user login credentials of the network device based on a user-selected password, and wherein pre-existing user login credentials of the network device are marked invalid.

In some implementations, the central management system sends the new password directly to the network device over the secure data tunnel or in response to a pull request from the network device.

In some implementations, the new password is associated with an administrator user account on the network device.

In some implementations, the new password is set to expire after a predetermined time interval passes.

In some implementations, after receiving the request from the network device to register the network device, the central management system receives an acknowledgement that the network device has performed a reboot operation that preserves settings of the network device.

In some implementations, the identifier of the network device is a serial number of the network device automatically obtained from hardware, firmware, software, or a combination thereof of the network device.

According to yet another aspect, portions, features, and implementation details of the systems, methods, non-transitory computer-readable media, and computer program products may be combined to form additional aspects, including some aspects which omit and/or modify some or portions of individual components or features, include additional components or features, and/or other modifications; and all such modifications are within the scope of this disclosure.

When network devices are registered to a cloud and centrally managed, the central management system can facilitate account recovery. For example, the network devices may be, as non-limiting examples, switches. Upon registration with the central management system, a switch establishes a secure tunnel with the central management system. This registration process is plug-and-play, requiring no settings changes on the switch. Hence, even if the password is lost, the switch can easily be registered to the central management system.

The central management system, utilizing the established notification tunnel back to the cloud, can either notify the switch directly of a new password or instruct the switch to securely pull a new password form the central management system and reset it. This ensures a secure and seamless password recovery process, preserving the switch's configurations and avoiding downtime.

The techniques presented in the present disclosure provide certain advantages. For example, the techniques provide for seamless account recovery. The central management system facilitates easy account recovery without requiring a factory reset. The techniques avoid the loss of device configurations (e.g., for a switch) by eliminating the need for a factory reset.

The techniques also ameliorate potential security risks. While secure, the system's reliance on network communication introduces potential security risks if not properly managed. The techniques provide loss prevention. The techniques eliminate the risk associated with losing the factory default password provided on a sticker. The techniques provide enhanced security. The techniques ensure that password resets are handled securely though the central management system.

### BRIEF DESCRIPTION OF THE DRAWINGS

The foregoing and other objects, features, and advantages of the devices, systems, and methods described herein will be apparent from the following description of particular implementations thereof, as illustrated in the accompanying drawings. The drawings are not necessarily to scale, emphasis instead being placed upon illustrating the principles of the devices, systems, and methods described herein.

FIG. 1 depicts a block diagram of a threat management system, in accordance with some implementations.

FIG. 2 depicts a block diagram of a threat management system, in accordance with some implementations.

FIG. 3 shows a system for enterprise network threat detection, in accordance with some implementations.

FIG. 4 illustrates a threat management system, in accordance with some implementations.

FIG. 5 illustrates a network device registered to a central management system and a related interaction, in accordance with some implementations.

FIG. 6A illustrates interactions between a network device, a central management system, and a user device, in accordance with some implementations.

FIG. 6B illustrates additional interactions between a network device, a central management system, and a user device, in accordance with some implementations.

FIG. 7 illustrates a flow chart of an example method for secure password reset performed by a user device, in accordance with some implementations.

FIG. 8 illustrates a flow chart of an example method for secure password reset performed by a network device, in accordance with some implementations.

FIG. 9 illustrates a flow chart of an example method for secure password reset performed by a central management system, in accordance with some implementations.

FIG. 10 illustrates a switch, in accordance with some implementations.

### DETAILED DESCRIPTION

Implementations are now described with reference to the accompanying figures. The foregoing may, however, be implemented in many different forms and should not be construed as limited to the illustrated implementations set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described implementations. Where ranges of values are provided, they are also intended to include each value within the range as if set forth individually, unless expressly stated to the contrary. The use of any and all examples, or language presenting examples, (“e.g.,” “such as,” or the like) provided herein, is intended merely to better illuminate the implementations and does not pose a limitation on the scope of the implementations. No language in the specification should be construed as indicating any unclaimed element as essential to the practice of the implementations.

In the following description, it is understood that terms such as “first,” “second,” “top,” “bottom,” “up,” “down,” and the like, are words of convenience and are not to be construed as limiting terms.

It should also be understood that endpoints, devices, compute instances, or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

As described herein, a threat management system may use a Sensor, Events, Analytics, and Response (SEAR) approach to protect enterprises against cybersecurity threats.

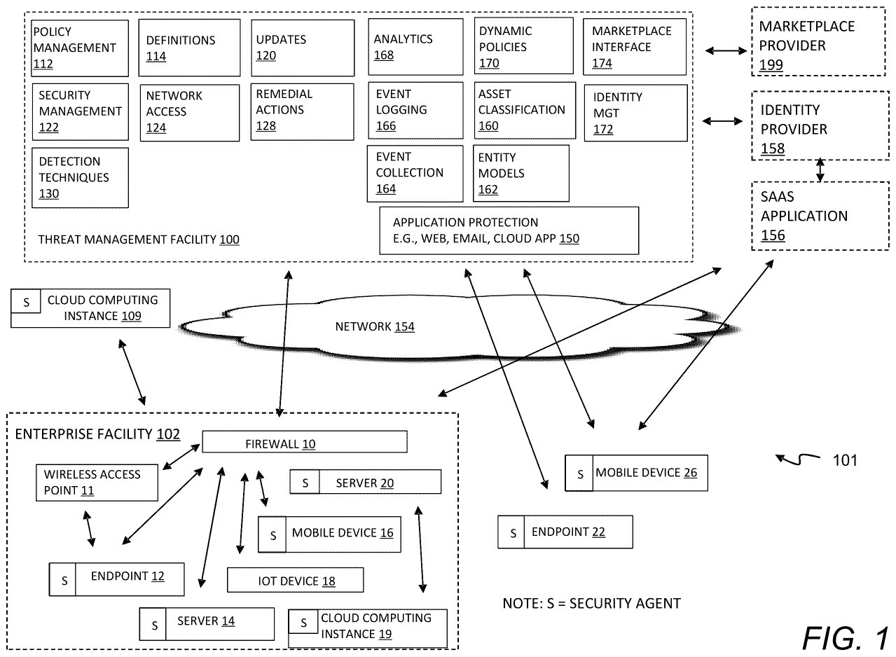

FIG. 1 depicts a block diagram of a threat management system 101, in accordance with some implementations, providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In implementations, the threat management facility 100 may provide protection from a variety of threats to a variety of compute instances in a variety of locations and network configurations.

Just as one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, an example enterprise facility 102 may be or may include any networked computer-based infrastructure. For example, the enterprise facility 102 may be corporate, commercial, organizational, educational, governmental, or the like. As home networks get more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus and located in one or in a plurality of geographical locations. The configuration of the enterprise facility as shown is merely an example, and it will be understood that there may be any number of compute instances, less or more of each type of compute instances, and other types of compute instances. As shown, the example enterprise facility includes a firewall 10, a wireless access point 11, an endpoint 12, a server 14, a mobile device 16, an appliance or IOT device 18, a cloud computing instance 19, and a server 20. Again, the compute instances 10-20 depicted are examples, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access rules facility 124, remedial action facility 128, detection techniques facility 130, application protection facility 150, asset classification facility 160, entity model facility 162, event collection facility 164, event logging facility 166, analytics facility 168, dynamic policies facility 170, identity management facility 172, and marketplace management facility 174, as well as other facilities. For example, there may be a testing facility, a threat research facility, and other facilities. It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility. Some or all of one or more of the facilities 100, 112-174 may be provided on the same physical hardware or logical resource as a gateway, such as a firewall 10, or wireless access point 11. Some or all of one or more of the facilities may be provided on one or more cloud servers that are operated by the enterprise or by a security service provider, such as the cloud computing instance 109.

In implementations, a marketplace provider 199 may make available one or more additional facilities to the enterprise facility 102 via the threat management facility 100. The marketplace provider may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider may be a specialized analytics provider; and so on. The marketplace provider 199, with appropriate permissions and authorization, may receive and send events, observations, inferences, controls, convictions, policy violations, or other information to the threat management facility. For example, the marketplace provider 199 may subscribe to and receive certain events, and in response, based on the received events and other events available to the marketplace provider 199, send inferences to the marketplace interface, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider may be any system or entity that creates, maintains, and manages identity information for principals while providing authentication services to relying party applications, e.g., within a federation or distributed network. The identity provider may, for example, offer user authentication as a service, where other applications, such as web applications, outsource the user authentication step to a trusted identity provider.

In implementations, the identity provider 158 may provide user identity information, such as multi-factor authentication, to a SaaS application. Centralized identity providers such as Microsoft Azure, may be used by an enterprise facility instead of maintaining separate identity information for each application or group of applications, and as a centralized point for integrating multifactor authentication. In implementations, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 can inform the identity provider 158, and the identity provider 158 may take steps to address the potential risk, such as to confirm the identity of the user, confirm that the user has approved the SaaS application access, remediate the user's system, or such other steps as may be useful.

In implementations, threat protection provided by the threat management facility 100 may extend beyond the network boundaries of the enterprise facility 102 to include clients (or client facilities) such as an endpoint 22 outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop. While threats may come from a variety of sources, such as from network threats, physical proximity threats, secondary location threats, the compute instances 10-26 may be protected from threats even when a compute instance 10-26 is not connected to the enterprise facility 102 network, such as when compute instances 22, 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Example commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network, or combination of these.

In implementations, aspects of the threat management facility 100 may be provided as a stand-alone solution. In other implementations, aspects of the threat management facility 100 may be integrated into a third-party product. An application programming interface (e.g. a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to directly 100. Alternatively, the threat management facility may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In implementations, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in the security agent of an endpoint 12, in a wireless access point 11 or firewall 10, as part of application protection 150 provided by the cloud, and so on.

In an implementation, the security management facility 122 may provide for email security and control, for example to target spam, viruses, spyware, and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an implementation, security management facility 122 may provide for web security and control, for example, to detect or block viruses, spyware, malware, unwanted applications, help control web browsing, and the like, which may provide comprehensive web access control enabling safe, productive web browsing. Web security and control may provide Internet use policies, reporting on suspect compute instances, security and content filtering, active monitoring of network traffic, URI filtering, and the like. Aspects of the web security and control may be provided, for example, in the security agent of an endpoint 12, in a wireless access point 11 or firewall 10, as part of application protection 150 provided by the cloud, and so on.

In an implementation, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In implementations, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an implementation, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an implementation, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data can be made. Aspects of reputation filtering may be provided, for example, in the security agent of an endpoint 12, in a wireless access point 11 or firewall 10, as part of application protection 150 provided by the cloud, and so on. In implementations, some reputation information may be stored on a compute instance 10-26, and other reputation data available through cloud lookups to an application protection lookup database, such as may be provided by application protection 150.

In implementations, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In implementations, feedback may enable the evaluation or profiling of client actions that are violations of policy that may provide a predictive model for the improvement of enterprise policies.

An update management facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In implementations, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Examples of rules include access permissions associated with networks, applications, compute instances, users, content, data, and the like. The policy management facility 112 may use a database, a text file, other data store, or a combination to store policies. In an implementation, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. Example policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions but may otherwise preserve network bandwidth for other activities by restricting the use of IM to personnel that need access for a specific purpose. In an implementation, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In implementations, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of USB disks, and policy management 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In implementations, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access to data and network resources may be restricted when they are installed and running. In the case where such applications are services which are provided indirectly through a third-party product, the applicable application or processes may be suspended until action is taken to remove or disable the third-party product.

The policy management facility 112 may also require update management (e.g., as provided by the update facility 120). Update management for the security facility 122 and policy management facility 112 may be provided directly by the threat management facility 100, or, for example, by a hosted system. In implementations, the threat management facility 100 may also provide for patch management, where a patch may be an update to an operating system, an application, a system tool, or the like, where one of the reasons for the patch is to reduce vulnerability to threats.

In implementations, the security facility 122 and policy management facility 112 may push information to the enterprise facility 102 network and/or the compute instances 10-26, the enterprise facility 102 network and/or compute instances 10-26 may pull information from the security facility 122 and policy management facility 112, or there may be a combination of pushing and pulling of information. For example, the enterprise facility 102 network and/or compute instances 10-26 may pull update information from the security facility 122 and policy management facility 112 via the update facility 120, an update request may be based on a time period, by a certain time, by a date, on demand, or the like. In another example, the security facility 122 and policy management facility 112 may push the information to the enterprise facility's 102 network and/or compute instances 10-26 by providing notification that there are updates available for downloading and/or transmitting the information. In an implementation, the policy management facility 112 and the security facility 122 may work in concert with the update management facility 120 to provide information to the enterprise facility's 102 network and/or compute instances 10-26. In various implementations, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that can be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In implementations, the threat management facility 100 and the compute instances 10-26 may be provided with new definitions periodically to include most recent threats. Updating of definitions may be managed by the update facility 120 and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a compute instance 22, 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an implementation, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access rule facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, MacOS, Linux, Android, and iOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility may include entity models 162. The entity models may be used, for example, to determine the events that are generated by assets. For example, some operating systems may provide useful information for detecting or identifying events. For examples, operating systems may provide process and usage information that accessed through an API. As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection facility 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. An example event may be communication of a specific packet over the network. Another example event may be identification of an application that is communicating over a network.

The event logging facility 166 may be used to store events collected by the event collection facility 164. The event logging facility 166 may store collected events so that they can be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may be used to remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 122 may take any steps or deploy any measures suitable for addressing a detection of a threat, potential threat, policy violation or other event, code or activity that might compromise security of a computing instance 10-26 or the enterprise facility 102.

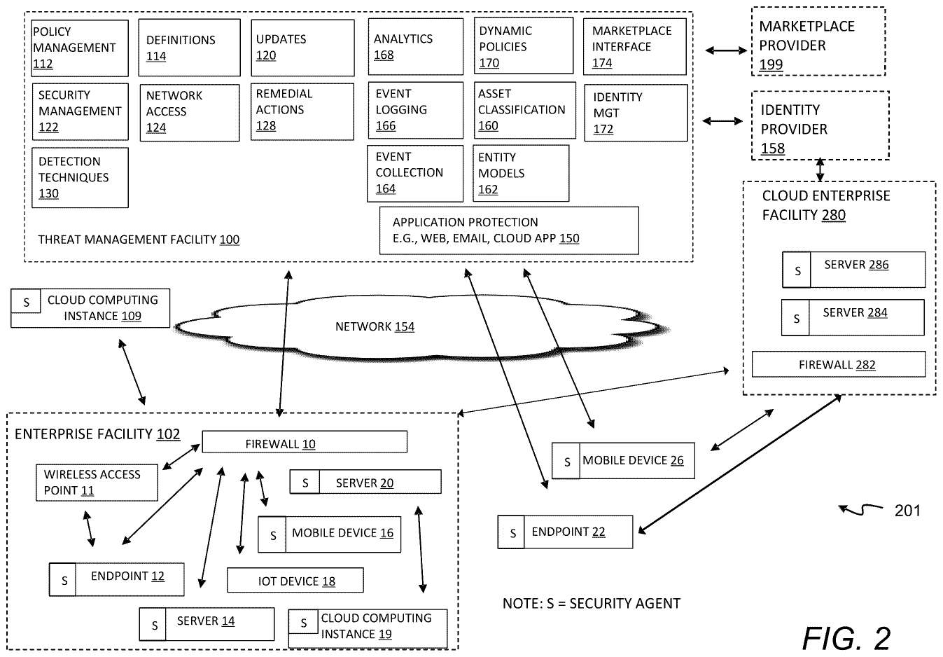

FIG. 2 depicts a block diagram of a threat management system 201, in accordance with some implementations, such as any of the threat management systems described herein, and including a cloud enterprise facility 280. The cloud enterprise facility 280 may include servers 284, 286, and a firewall 282. The servers 284, 286 on the cloud enterprise facility 280 may run one or more enterprise applications and make them available to the enterprise facilities 102 compute instances 10-26. It should be understood that there may be any number of servers 284, 286 and firewalls 282, as well as other compute instances in a given cloud enterprise facility 280. It also should be understood that a given enterprise facility may use both SaaS applications 156 and cloud enterprise facilities 280, or, for example, a SaaS application 156 may be deployed on a cloud enterprise facility 280. As such, the configurations in FIG. 1 and FIG. 2 are shown by way of examples and not exclusive alternatives.

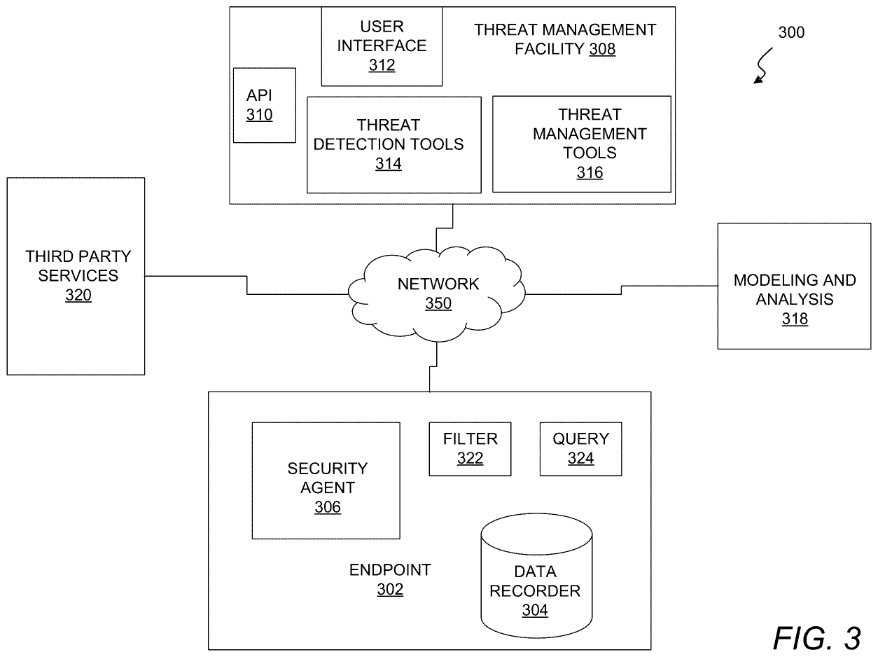

FIG. 3 shows a system 300 for enterprise network threat detection, in accordance with some implementations. The system 300 may use any of the various tools and techniques for threat management contemplated herein. In the system, a number of endpoints such as the endpoint 302 may log events in a data recorder 304. A local agent on the endpoint 302 such as the security agent 306 may filter this data and feed a filtered data stream to a threat management facility 308 such as a central threat management facility or any of the other threat management facilities described herein. The threat management facility 308 can locally or globally tune filtering by local agents based on the current data stream and can query local event data recorders for additional information where necessary or helpful in threat detection or forensic analysis. The threat management facility 308 may also or instead store and deploys a number of security tools such as a web-based user interface that is supported by machine learning models to aid in the identification and assessment of potential threats by a human user. This may, for example, include machine learning analysis of new code samples, models to provide human-readable context for evaluating potential threats, and any of the other tools or techniques described herein. More generally, the threat management facility 308 may provide any of a variety of threat management tools 316 to aid in the detection, evaluation, and remediation of threats or potential threats.

The threat management facility 308 may perform a range of threat management functions such as any of those described herein. The threat management facility 308 may generally include an application programming interface 310 to third party services 320, a user interface 312 for access to threat management and network administration functions, and a number of threat detection tools 314.

In general, the application programming interface 310 may support programmatic connections with third party services 320. The application programming interface 310 may, for example, connect to Active Directory or other customer information about files, data storage, identities and user profiles, roles, access privileges and so forth. More generally the application programming interface 310 may provide a programmatic interface for customer or other third party context, information, administration and security tools, and so forth. The application programming interface 310 may also or instead provide a programmatic interface for hosted applications, identity provider integration tools or services, and so forth.

The user interface 312 may include a website or other graphical interface or the like and may generally provide an interface for user interaction with the threat management facility 308, e.g., for threat detection, network administration, audit, configuration and so forth. This user interface 312 may generally facilitate human curation of intermediate threats as contemplated herein, e.g., by presenting intermediate threats along with other supplemental information, and providing controls for user to dispose of such intermediate threats as desired, e.g., by permitting execution or access, by denying execution or access, or by engaging in remedial measures such as sandboxing, quarantining, vaccinating, and so forth.

The threat detection tools 314 may be any of the threat detection tools, algorithms, techniques or the like described herein, or any other tools or the like useful for detecting threats or potential threats within an enterprise network. This may, for example, include signature based tools, behavioral tools, machine learning models, and so forth. In general, the threat detection tools 314 may use event data provided by endpoints within the enterprise network, as well as any other available context such as network activity, heartbeats, and so forth to detect malicious software or potentially unsafe conditions for a network or endpoints connected to the network. In one aspect, the threat detection tools 314 may usefully integrate event data from a number of endpoints (including, e.g., network components such as gateways, routers, and firewalls) for improved threat detection in the context of complex or distributed threats. The threat detection tools 314 may also or instead include tools for reporting to a separate modeling and analysis platform 318, e.g., to support further investigation of security issues, creation or refinement of threat detection models or algorithms, review and analysis of security breaches, and so forth.

The threat management tools 316 may generally be used to manage or remediate threats to the enterprise network that have been identified with the threat detection tools 314 or otherwise. Threat management tools 316 may, for example, include tools for sandboxing, quarantining, removing, or otherwise remediating or managing malicious code or malicious activity, e.g., using any of the techniques described herein.

The endpoint 302 may be any of the endpoints or other compute instances or the like described herein. This may, for example, include end-user computing devices, mobile devices, firewalls, gateways, servers, routers and any other computing devices or instances that might connect to an enterprise network. As described above, the endpoint 302 may generally include a security agent 306 that locally supports threat management on the endpoint 302, such as by monitoring for malicious activity, managing security components on the endpoint 302, maintaining policy compliance, and communicating with the threat management facility 308 to support integrated security protection as contemplated herein. The security agent 306 may, for example, coordinate instrumentation of the endpoint 302 to detect various event types involving various computing objects on the endpoint 302 and supervise logging of events in a data recorder 304. The security agent 306 may also or instead scan computing objects such as electronic communications or files, monitor behavior of computing objects such as executables, and so forth. The security agent 306 may, for example, apply signature-based or behavioral threat detection techniques, machine learning models (e.g. models developed by the modeling and analysis platform), or any other tools or the like suitable for detecting malware or potential malware on the endpoint 302.

The data recorder 304 may log events occurring on or related to the endpoint. This may, for example, include events associated with computing objects on the endpoint 302 such as file manipulations, software installations, and so forth. This may also or instead include activities directed from the endpoint 302, such as requests for content from Uniform Resource Locators or other network activity involving remote resources. The data recorder 304 may record data at any frequency and any level of granularity consistent with proper operation of the endpoint 302 in an intended or desired manner.

The endpoint 302 may include a filter 322 to manage a flow of information from the data recorder 304 to a remote resource such as the threat detection tools 314 of the threat management facility 308. In this manner, a detailed log of events may be maintained locally on each endpoint, while network resources can be conserved for reporting of a filtered event stream that contains information believed to be most relevant to threat detection. The filter 322 may also or instead be configured to report causal information that causally relates collections of events to one another. In general, the filter 322 may be configurable so that, for example, the threat management facility 308 can increase or decrease the level of reporting based on a current security status of the endpoint, a group of endpoints, the enterprise network, and the like. The level of reporting may also or instead be based on currently available network and computing resources, or any other appropriate context.

In another aspect, the endpoint 302 may include a query interface 324 so that remote resources such as the threat management facility 308 can query the data recorder 304 remotely for additional information. This may include a request for specific events, activity for specific computing objects, or events over a specific time frame, or some combination of these. Thus, for example, the threat management facility 308 may request all changes to the registry of system information for the past forty eight hours, all files opened by system processes in the past day, all network connections or network communications within the past hour, or any other parametrized request for activities monitored by the data recorder 304. In another aspect, the entire data log, or the entire log over some predetermined window of time, may be request for further analysis at a remote resource.

It will be appreciated that communications among third party services 320, a threat management facility 308, and one or more endpoints such as the endpoint 302 may be facilitated by using consistent naming conventions across products and machines. For example, the system 300 may usefully implement globally unique device identifiers, user identifiers, application identifiers, data identifiers, Uniform Resource Locators, network flows, and files. The system may also or instead use tuples to uniquely identify communications or network connections based on, e.g., source and destination addresses and so forth.

According to the foregoing, a system disclosed herein includes an enterprise network, and endpoint coupled to the enterprise network, and a threat management facility coupled in a communicating relationship with the endpoint and a plurality of other endpoints through the enterprise network. The endpoint may have a data recorder that stores an event stream of event data for computing objects, a filter for creating a filtered event stream with a subset of event data from the event stream, and a query interface for receiving queries to the data recorder from a remote resource, the endpoint further including a local security agent configured to detect malware on the endpoint based on event data stored by the data recorder, and further configured to communicate the filtered event stream over the enterprise network. The threat management facility may be configured to receive the filtered event stream from the endpoint, detect malware on the endpoint based on the filtered event stream, and remediate the endpoint when malware is detected, the threat management facility further configured to modify security functions within the enterprise network based on a security state of the endpoint.

The threat management facility may be configured to adjust reporting of event data through the filter in response to a change in the filtered event stream received from the endpoint. The threat management facility may be configured to adjust reporting of event data through the filter when the filtered event stream indicates a compromised security state of the endpoint. The threat management facility may be configured to adjust reporting of event data from one or more other endpoints in response to a change in the filtered event stream received from the endpoint. The threat management facility may be configured to adjust reporting of event data through the filter when the filtered event stream indicates a compromised security state of the endpoint. The threat management facility may be configured to request additional data from the data recorder when the filtered event stream indicates a compromised security state of the endpoint. The threat management facility may be configured to request additional data from the data recorder when a security agent of the endpoint reports a security compromise independently from the filtered event stream. The threat management facility may be configured to adjust handling of network traffic at a gateway to the enterprise network in response to a predetermined change in the filtered event stream. The threat management facility may include a machine learning model for identifying potentially malicious activity on the endpoint based on the filtered event stream. The threat management facility may be configured to detect potentially malicious activity based on a plurality of filtered event streams from a plurality of endpoints. The threat management facility may be configured to detect malware on the endpoint based on the filtered event stream and additional context for the endpoint.

The data recorder may record one or more events from a kernel driver. The data recorder may record at least one change to a registry of system settings for the endpoint. The endpoints may include a server, a firewall for the enterprise network, a gateway for the enterprise network, or any combination of these. The endpoint may be coupled to the enterprise network through a virtual private network or a wireless network. The endpoint may be configured to periodically transmit a snapshot of aggregated, unfiltered data from the data recorder to the threat management facility for remote storage. The data recorder may be configured to delete records in the data recorder corresponding to the snapshot in order to free memory on the endpoint for additional recording.

For example, endpoint 302, threat management facility 308, modeling and analysis 318, and third party services 320 may share information with one another over network 350 (which may be the Internet or another cloud network).

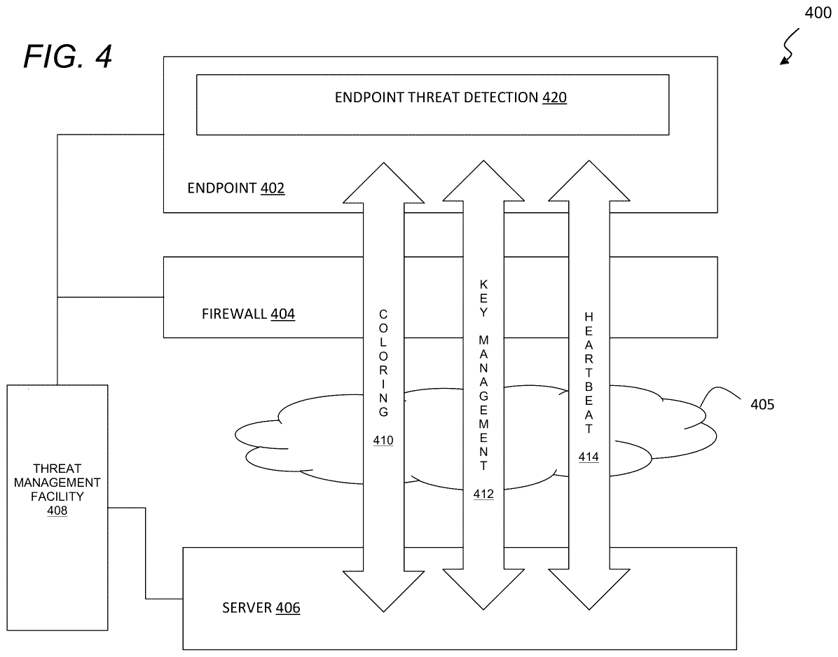

FIG. 4 illustrates a threat management system 400, in accordance with some implementations. In general, the system may include an endpoint 402, a firewall 404, a server 406 and a threat management facility 408 coupled to one another directly or indirectly through a data network 405, all as generally described above. Each of the entities depicted in FIG. 4 may, for example, be implemented on one or more computing devices such as the computing device described herein. A number of systems may be distributed across these various components to support threat detection, such as a coloring system 410, a key management system 412 and a heartbeat system 414, each of which may include software components executing on any of the foregoing system components, and each of which may communicate with the threat management facility 408 and an endpoint threat detection agent 420 executing on the endpoint 402 to support improved threat detection and remediation.

The coloring system 410 may be used to label or color software objects for improved tracking and detection of potentially harmful activity. The coloring system 410 may, for example, label files, executables, processes, network communications, data sources and so forth with any suitable information. A variety of techniques may be used to select static and/or dynamic labels for any of these various software objects, and to manage the mechanics of applying and propagating coloring information as appropriate. For example, a process may inherit a color from an application that launches the process. Similarly, a file may inherit a color from a process when it is created or opened by a process, and/or a process may inherit a color from a file that the process has opened. More generally, any type of labeling, as well as rules for propagating, inheriting, changing, or otherwise manipulating such labels, may be used by the coloring system 410 as contemplated herein.

The key management system 412 may support management of keys for the endpoint 402 in order to selectively permit or prevent access to content on the endpoint 402 on a file-specific basis, a process-specific basis, an application-specific basis, a user-specific basis, or any other suitable basis in order to prevent data leakage, and in order to support more fine-grained and immediate control over access to content on the endpoint 402 when a security compromise is detected. Thus, for example, if a particular process executing on the endpoint is compromised, or potentially compromised or otherwise under suspicion, keys to that process may be revoked in order to prevent, e.g., data leakage or other malicious activity.

The heartbeat system 414 may be used to provide periodic or aperiodic information from the endpoint 402 or other system components about system health, security, status, and so forth. A heartbeat may be encrypted or plaintext, or some combination of these, and may be communicated unidirectionally (e.g., from the endpoint 408 to the threat management facility 408) or bidirectionally (e.g., between the endpoint 402 and the server 406, or any other pair of system components) on any useful schedule.

In general, these various monitoring and management systems may cooperate to provide improved threat detection and response. For example, the coloring system 410 may be used to evaluate when a particular process is potentially opening inappropriate files based on an inconsistency or mismatch in colors, and a potential threat may be confirmed based on an interrupted heartbeat from the heartbeat system 414. The key management system 412 may then be deployed to revoke keys to the process so that no further files can be opened, deleted, or otherwise modified. More generally, the cooperation of these systems enables a wide variety of reactive measures that can improve detection and remediation of potential threats to an endpoint.

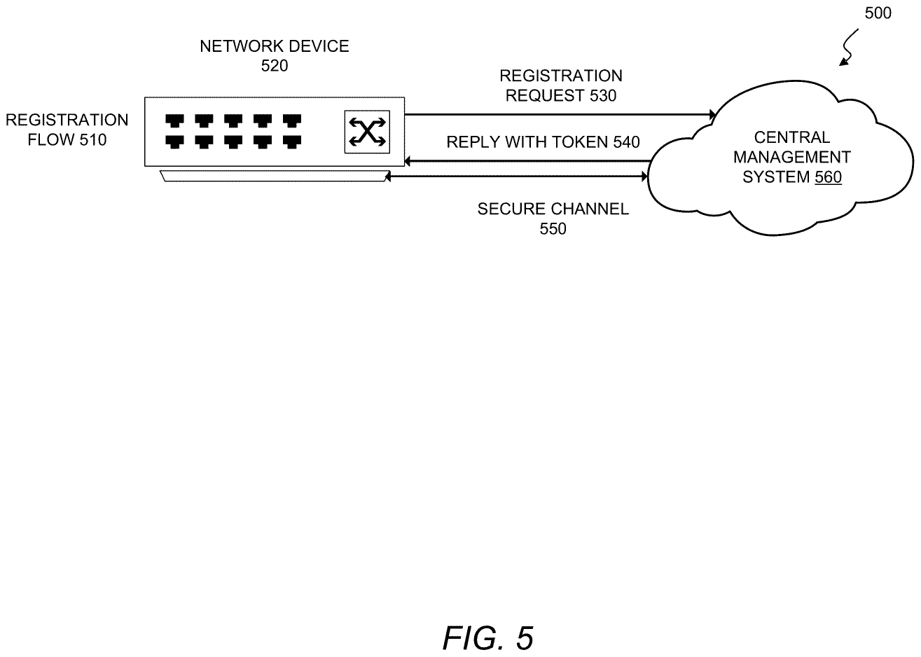

FIG. 5 illustrates a network device registered to a central management system and a related interaction 500, in accordance with some implementations. Specifically, FIG. 5 illustrates a registration flow 510. FIG. 5 illustrates a network device 520. While network device 520 may be a switch, this is merely an example network device and other network devices may be registered to the central management system. For example, network device 520 may correspond to another network device or combination of devices, such as a router, a hub, a bridge, a repeater, a modem, a gateway, a network interface card (NIC), a load balancer, an access point, a wireless controller, and/or a device that integrates combinations of these functions into a single device.

Network device 520 may make a registration request 530 to register the network device 520 with a password (e.g., a one-time password (OTP) or another temporary password such as a device certificate) and send such a registration request 530 to a central management system 560. In response, the central management system 560 may send an authentication token 540 to network device 520. Such an authentication token 540 may be a JavaScript Object Notion (JSON) Web Token (JWT). By using the authentication token 540, the network device 520 establishes a secure data channel between the central management system 560 and the network device 520. For example, the secure data channel may be a WebSocket channel 550. In some implementations, the secure data channel may take other forms.

FIG. 5 illustrates network device 520 and central management system 560. Together, these components work together to provide part of a secure reset process. These components may operate as a part of a threat management system. For example, FIG. 1 shows a threat management system distributed over the cloud. FIG. 2 shows a slightly different threat management system distributed over the cloud. FIG. 3 shows a system for enterprise network threat detection. FIG. 4 shows another threat management system.

The secure reset process may be integrated into a threat management system. For example, changing a password as provided in the present disclosure may help improve threat management. The network device 520 may be implemented as one or more of the devices illustrated in FIG. 1 integrated into enterprise facility 102, such as the firewall 10, wireless access point 11, the endpoint 12, the server 14, the mobile device 16, the IOT device 18, the cloud computing instance 19, or the server 20. Likewise, the network device 520 may be implemented as endpoint 22 or mobile device 26.

The central management system 560 may be implemented at threat management facility 100, cloud computing instance 109, and/or network 154. Thus, the discussion of FIG. 1 provides additional context, background, and explanation for possible implementations of network device 520 and central management system 560.

FIG. 2 shows similar elements to those discussed above with respect to FIG. 1, and the disclosure of FIG. 2 also provides additional context, background, and explanation for possible implementations of network device 520 and central management system 560. FIG. 3 shows an alternative architecture for enterprise threat detection. The network device 520 may be implemented as one or more of the devices illustrated in FIG. 3 integrated into endpoint 302, such as by components of endpoint 302 such as data recorder 304, security agent 306, filter 322, query 324, and modeling and analysis 318 and third party services 320 modules. These may be connected over network 350 with a threat management facility 308.

The central management system 560 may also be implemented as one or more of the devices illustrated in FIG. 3, such as thread management facility 308 and by its components such as API 310, user interface 312, threat detection tools 314, and threat management tools 316.

FIG. 4 shows an alternative architecture for a threat management system. For example, network device 520 may correspond to endpoint 402 with integrated endpoint threat detection 420 and/or the firewall 404. The central management system 560 may correspond to server 406 and/or threat management facility 408. There may be an interaction between the network device 520 and the central management system 560 corresponding to the endpoint 402 interacting with server 406 mediated by a firewall 404, including coloring 410, key management 412, and/or heartbeat 414 over a data network 405.

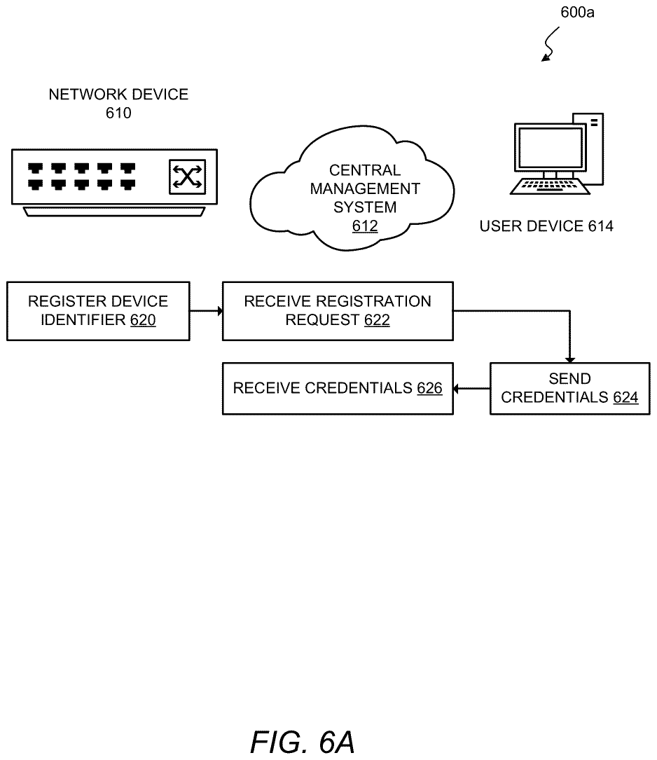

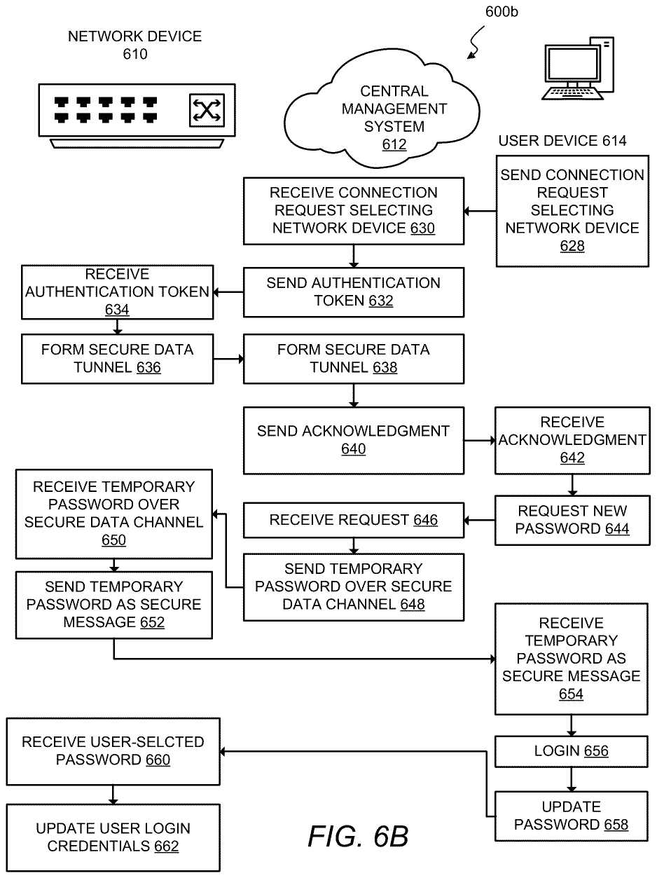

FIG. 6A illustrates interactions 600a between a network device, a central management system, and a user device, in some implementations. FIG. 6A illustrates network device 610, central management system 612, and user device 614. Network device 610 corresponds to network device 520 in FIG. 5. In FIG. 6A, the diagram illustrates operations performed by network device 610 in a column beneath network device 610, operations performed by central management system 612 in a column beneath central management system 612, and operations performed by user device 614 in a column beneath user device 614.

FIG. 6A and FIG. 6B may also be provided with further context, background, and explanation in the discussion of FIGS. 1-4. For example, network device 610 may correspond to network device 520 in FIG. 5, and the discussion of the applicability of FIGS. 1-4 to network device 520 applies to network device 610 in FIGS. 6A-6B. As another example, central management system 612 may correspond to central management system 560 in FIG. 5, and the discussion of the applicability of FIGS. 1-4 to central management system 560 applies to central management system 612 in FIGS. 6A-6B.

Furthermore, FIGS. 6A and 6B illustrate one embodiment of the user device 614. As with network device 520, FIGS. 1-4 also provides additional context, background, and explanation for possible implementations of user device 614. For example, in FIG. 1, the user device 614 may correspond to one or more components and/or devices of the enterprise facility 102, such as the firewall 10, wireless access point 11, the endpoint 12, the server 14, the mobile device 16, the IOT device 18, the cloud computing instance 19, or the server 20. Likewise, the user device 614 may be implemented as endpoint 22 or mobile device 26. FIG. 2 shows similar elements to those discussed above with respect to FIG. 1, and the disclosure of FIG. 2 also provides additional context, background, and explanation for possible implementations of the user device 614.

FIG. 3 shows an alternative architecture for enterprise threat detection. The user device 614 may be implemented as one or more of the devices illustrated in FIG. 3 integrated into endpoint 302, and its components such as data recorder 304, security agent 306, filter 322, query 324, and modeling and analysis 318 and third party services 320. FIG. 4 shows another threat management system. For example, the user device 614 may correspond to the endpoint 402 and the associated endpoint threat detection 420 and/or the firewall 404.

While the network device 610 is illustrated as a switch in FIG. 6A, other network devices 610 may be used in lieu of and/or in combination with a switch as the network device 610. Examples of such alternative devices are presented in the discussion of the network device 520 in the discussion of FIG. 5. While the central management system 612 is illustrated as a cloud platform, it is understood that the central management system 612 may be implemented and/or provided in various ways. For example, the central management system 612 may be a server on the cloud that provides management functions through a web interface, or the central management system 612 may be distributed in various ways (e.g., one server or multiple servers and/or use of third-party cloud hosting facilities).

For example, central management system 612 may be implemented as a cloud-native application and may be hosted on various public cloud platforms. The central management system 612 may be managed in a region-specific manner and replicated with redundancy across multiple specific data centers. This approach may provide high availability and seamless failure response.

Providing a cloud-native application facilitates scalability and fluctuating workload levels. Users may be able to choose a specific region where server accounts are to be hosted. Based on the region selection, data is hosted accordingly to ensure data residency and to meet compliance specifications. To assist in this, replication of data across multiple data centers may occur within the given region. For example, data centers may be localized to specific countries, specific regions, and/or specific continents.

User device 614 is illustrated as a desktop PC (a tower PC with a keyboard and monitor), but user device be any user device, including computing device(s) such as one or more of a laptop PC, a workstation, a thin client device, a smartphone, a tablet, another mobile device, a server computer, and/or a terminal computer.

User device 614 may also include a printer (e.g., inkjet printer, laser printer, 3D printer) or Internet of Things (IoT) device(s), such as smart speakers, security systems, smart home devices (smart thermostats, smart lighting, smart appliances, smart voice assistants, air quality monitors, etc.), wearable device(s) (smartwatches, fitness trackers, wearable medical devices), smart cars, and applied IoT (agriculture, healthcare, industrial devices). User device 614 may also include one or more music players, video game consoles, personal digital assistance (PDAs), media players, point-of-sale terminals, ATMs, and/or virtual machine(s) (a software-based computer running on a physical host). While user device 614 is illustrated as being separate from network device 610, it is also possible for all or some of the functions of user device 614 to be integrated into network device 610 and/or central management system 612.

FIG. 6A illustrates interactions between a network device 610, the central management system 612, and the user device 614, in accordance with some implementations. In one embodiment, two blocks may occur before the main password reset process in a method 600a. For example, network device 610 registers a device identifier at block 620. Central management system 612 receives the registration request at block 622. For example, network device 610 may have internet connectivity. In some implementations, the network device 610 may automatically register with central management system 612.

In some implementations, a user of central management system 612 may log into an account, and interface with central management system 612 (e.g., using an appropriate web interface platform) to select network device management, add a network device, enter a serial number (or another identifier) of network device 610, and instruct the central management system 612 to register the network device. In some implementations, network device 610 may have a Trusted Platform Module (TPM) device certificate and it may be presented as an identifier for registration. A reboot of network device 610 may be required to complete the registration.

Further, user device 614 sends credentials to central management system 612 at block 624. After registration, at any time, a user device 614 may send credentials to a central management system 612 to access or configure network device 610. The credentials may include account credentials associated with a user of the network device and an identifier of the network device. Alternatively, the credentials may provide administrator access for central management system 612. These credentials may allow a user of the user device 614 to interact with central management system 616 to manage the password reset process. Central management system 612 receives the credentials at block 626. This receipt prepares central management system 612 to provide the secure password reset capability.

FIG. 6B illustrates additional interactions 600b between a network device, a central management system, and a user device, in accordance with some implementations. FIG. 6B also illustrates network device 610, central management system 612, and user device 614. These devices are the same as corresponding devices in FIG. 6A.

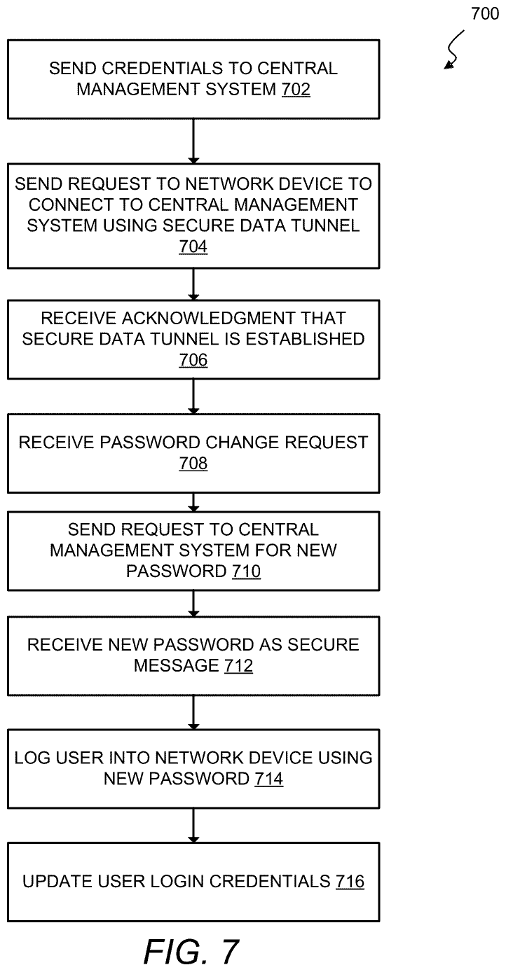

FIG. 6B illustrates a set of operations of a method 600b that results in a series of successive interactions between network device 610, central management system 612, and user device 614 that permit a secure password reset for network device 610. The method 600b is presented in the discussion of FIG. 6B at a high level. Additional details and explanations of these method steps are presented in the discussion of FIGS. 7-9.

Method 600b may begin at block 628, performed by user device 614. At block 628, a connection request selecting the network device 610 is sent from the user device 614 to the central management system 612. For example, the user device 614 may have logged into an account of the central management system 612, such as through a web portal (though alternatives are possible, such as a dedicated application or mobile app). Such an account allows the user device 614 to send an instruction that the central management system 612 should participate in a secure connection with the network device 610 to allow secure sharing of an updated password. Block 628 may be followed by block 630. The operations performed in block 628, block 630, block 632, block 634, block 636, block 638, block 640, and block 642 happen immediately after registration and do not necessarily depend on user interaction. These operations may be automatic after registration and are initiated by the network device 610.

At block 630, a connection request selecting the network device 610 is received by the central management system 612. Based on receiving such a request, the central management system 612 prepares to form the secure data tunnel. Block 630 may be followed by block 632.

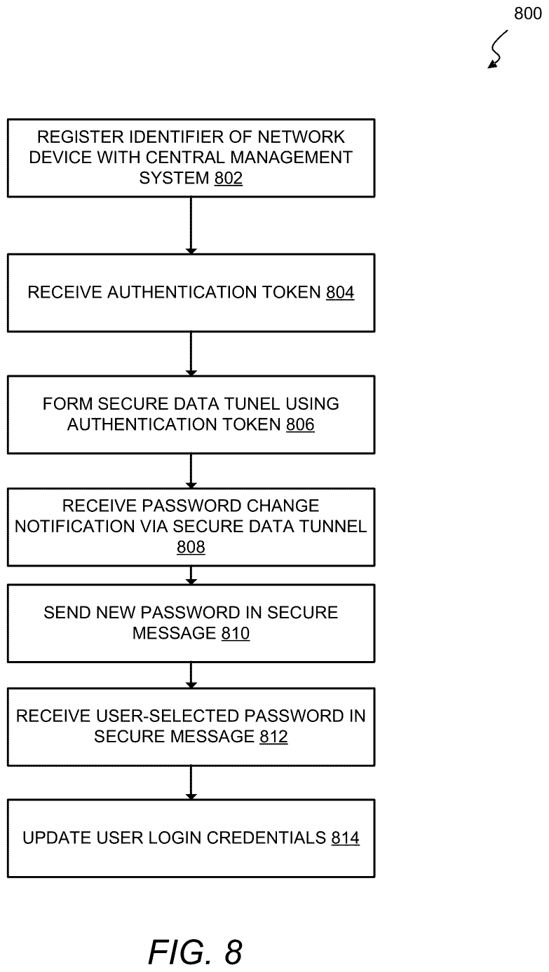

At block 632, the central management system 612 sends an authentication token to the network device 610. In some implementations, the authentication token is a JSON Web Token (JWT). Other types of tokens may be used in other implementations. Further details and alternatives are presented in the discussion of block 804 of FIG. 8. Block 632 may be followed by block 634.

At block 634, the network device 610 receives the authentication token sent by the central management system 612. Once the authentication token is received, the network device 610 prepares to form the secure data tunnel. Block 634 may be followed by block 636.

At block 636, the network device 610 forms a secure data tunnel with the central management system 612. In some implementations, the secure data tunnel is a WebSocket and is formed appropriately using a JWT token. Other non-limiting examples of secure data tunnels are presented in the discussion of block 704 of FIG. 7. Block 636 may be followed by block 638.

At block 638, the central management system 612 forms the secure data tunnel by interacting with the network device 610. The formation of the secure data tunnel between the central management system 612 and the network device 610 that occurs at block 636 and block 638 is an interactive process by which actions may be taken by network device 610 and/or central management system 612 to allow secure information sharing. Block 638 may be followed by block 640.

At block 640, the central management system 612 sends an acknowledgment message to the user device 614. The acknowledgment message indicates that the secure data tunnel between the network device 610 and the central management system 612 is active. Block 640 may be followed by block 642.

At block 642, the user device 614 receives the acknowledgment message. Once the acknowledgment message is sent and received, the user of the user device 614 is notified that it is possible to initiate the password reset process at the central management system 612. Block 642 may be followed by block 644.

At block 644, the user device 614 requests a new password. The new password request is sent to central management system 612. More particularly, the user device 614 may receive an appropriate input from a user of the user device 614 such as by using an input peripheral (e.g., keyboard, mouse, trackpad, trackball, track point, etc.), a voice command (e.g., received using a microphone), a touch input (e.g., received using a touchscreen and/or stylus), etc. Block 644 may be followed by block 646.

At block 646, the central management system 612 receives the request for the new password. In response to receiving the request, the central management system 612 may generate an appropriate temporary password to be used to help securely reset a password for the network device 610. While this description of block 646 refers to a password (which may be an alphanumeric string, a string of letters, a string of numbers, and/or a string including letters, numbers, and other characters, which may be represented using codes such as ASCII and/or Unicode), a password is not limited to such as string and may include other credentials. Block 646 may be followed by block 648.

At block 648, the temporary password is sent over the secure data channel. The temporary password may be protected in various ways. For example, the password may be encrypted. The encryption may be applied to the password itself and/or to the network connection used to send the temporary password.

For example, prior to providing the temporary password as a payload, the temporary password may be encrypted with a key, and the temporary password may be decrypted using a key. If the encryption key and the decryption key are the same, this is symmetric encryption, requiring a secure way to share the key between the receiver beforehand. Non-limiting examples of symmetric encryption are Advanced Encryption Standard (AES) and Blowfish. Alternatively, the key could be shared using a different channel. On receipt of this password by the network device 610, it could make an HTTP REST API call to fetch the key for decrypting the password.

Alternatively, asymmetric encryption uses a public key for encryption and a private key for decryption. This may avoid pre-shared secrets. Non-limiting examples of asymmetric encryption include Rivest-Shamir-Adleman (RSA) and Elliptic Curve Cryptography (ECC). The encryption may also involve generating and using a Content Encryption Key (CEK). In addition to encryption of the temporary key itself, the encryption may be applied to the connection.

Block 648 may be followed by block 650.

At block 650, the temporary password is received over the secure channel by the network device 610 from the central management system 612. The temporary password may be updated to a user-selected, permanent password. Such updating may occur separately as interaction between the network device 610 and the user device 614. Block 650 may be followed by block 652.

At block 652, the network device 610 sends the temporary password as a secure message to user device 614. Various techniques may be used to send the temporary password as a secure message. In some implementations, other techniques may be used to provide the user device 614 with access to the temporary password. For example, in some implementations the password may be sent directly from the central management system 612 itself to the user at the user device 614. In such implementations, the central management system 612 acts as an arbitrator between the user and the network device 610. Block 652 may be followed by block 654.

At block 654, the user device 614 receives the temporary password as a secure message from the network device 610. For example, the secure message may be sent a secure e-mail, a secure text message, a voice call, or a secure messaging app. Such content may be encrypted in various ways. The temporary password may be the payload of the secure message or may be part of an attachment. Once the user device 614 has the temporary password, the user device 614 may be able to access the network device 610.

By receiving a temporary password in this manner, the user device 614 can access the network device 610, even if the user has forgotten or needs to change the existing password (e.g., if the password is insecure, such as due to a security incursion or due to a routine password update for best practices for security). Moreover, the user does not need to factory reset the network device 610.

This avoids overwriting device settings of network device 610 and avoids the need to have access to a factory default password. Such a factory default password may be preserved on a sticker, but if the sticker is lost the password is lost as well, and a malicious actor may access the sticker and use the information on the sticker to access the network device 610 after a factor reset. Block 654 may be followed by block 656.

At block 656, the user of the user device 614 uses the temporary password to login to the network device 610. While not illustrated in FIG. 6B, there may be an additional step in which network device 610 accepts the temporary password as a one-time password (OTP) that permits the user device 614 a single login opportunity for the sole purpose of updating the temporary password with a more permanent user-selected password. Block 656 may be followed by block 658.

At block 658, the user updates the password at the user device 614. For example, the user device 614 may provide an appropriate interface that permits the user to enter a new, user-selected password. Such an interface may permit the user to enter a new password once or may permit the user to enter a new password once and confirm the new password one or more times. In various implementations, the interface used to enter the replacement password may have several aspects.

For example, when entering the replacement password, the replacement password may be visible, may be obscured with neutral characters (e.g., asterisks (“*”), pound signs (“#”), etc.), or may be provided with the ability to switch between being visible and being obscured. The replacement password may be entered once or may be entered once followed by being confirmed one or more times. The replacement process may involve one or more tasks performed by the user to demonstrate that the user is a human being. The user device may also suggest a password, such as a randomly generated secure password, and may permit the user to accept the suggested password. The user-selected password may meet a password policy specifying characteristics of the password.

Once the new password is entered and confirmed, the new password may be sent to network device 610. Block 658 may be followed by block 660.

At block 660, the network device 610 receives the user-selected password. For example, the user device 614 is logged into the network device 610 and the network device 610 is configured to update its password based on the user-selected password. Block 660 may be followed by block 662.

At block 662, the network device 610 updates the user login credentials. The updating may be implemented using software, firmware, hardware, or a combination thereof built into the network device 610. When performing the updating, pre-existing user login credentials may be marked invalid.

Once the user of the user device 614 receives the password, the user may be provided with an opportunity to select a replacement password. For example, the user may type a replacement password using a keyboard. Other implementations may use other forms of text entry to provide the replacement password, including but not limited to handwriting recognition, speech recognition, or use of a virtual keyboard.

Once the user device 614 establishes a user-selected password as a replacement password, the user device 614 sends the user-selected password via a secure message to the network device 610. The secure message used to send the user-selected password to the network device 610 may use a same messaging technology as that used to send the temporary password, or another messaging technology.

Network device 610 may be associated with user accounts (including one or more administrator user accounts) that are authenticated by corresponding passwords. While some implementations provide for the use of passwords as login credentials, it is recognized that similar credentials may be managed using techniques herein. Additionally, the login credentials managed herein may not be limited to traditional passwords. The techniques may be applied to personal identification numbers (PINs), which may be a numeric or alphanumeric string used to approve an action.

In some implementations, the techniques presented herein may be applied to update biometric authentication data (such as user-specific hashes or other data structures that enable authentication via fingerprint recognition, facial, recognition, retinal scans, and voice recognition, if permitted by users and in compliance with applicable regulations for use of such data). The techniques may also use passkeys in lieu of a traditional passwords. The techniques may also manage information for a magic link or email link (provided as an SMS message, a message for a dedicated messaging application, or a message sent as an email address). Similarly, the techniques may aid in the use of an emailed OTP (one-time password), a short-message service (SMS) or other messaging based OTP (one-time password), etc. The techniques may also operate in conjunction with single sign-on (SSO) credentials, social login credentials, and/or password managers.

The techniques may also use multiple credentials (e.g., two-factor authentication). For example, there may be a combination of a traditional password and facial recognition, or a combination of a traditional password and an email OTP. These are merely examples, and other login credentials may be used in combination with one another. In some implementations, there may be one-factor or two-factor credentials, but this is not limiting and three or more credentials may be used in some implementations.

For example, there may be an initial administrator password “XXXXX.” The initial administrator password may be replaced by temporary administrator password “SS@123” generated at the central management system 612, which may be associated with an expiry time (also referred to as an expiry window). An expiry time or expiry window may specify how long a user has to update the password. For example, an expiry window may be a preset amount of time, such as fifteen minutes (as a non-limiting example). The expiry window may be a user-set value. If the expiry window is a user-set value, the user may specify that the password does not expire, or that the password expires upon another condition (e.g., a signal that the password has somehow been compromised).

After the expiry time or expiry window lapses, the temporary password may no longer be valid. The password for the network device 610, after the lapsing of the expiry time or expiry window, may revert to its previous value, may change to a default value, or may be locked down (so that the network device 610 cannot be accessed until the password process is completed again, successfully).

FIG. 6B illustrates that after the user-selected password is sent via the secure message, initial administrator password “XXXXX” is replaced with updated administrator “YYYYY” as selected by a user at the user device. Network device 610 may also mark the initial administrator password “XXXXX” as expired or otherwise invalid.

FIG. 7 illustrates a flow chart of an example method 700 for secure password reset performed by a user device, in accordance with some implementations. Method 700 may begin at block 702. Various secure techniques are used by a user device to securely reset a password for a network device. For example, the user device may establish a connection with a central management system on the cloud and initiate a password reset process for a specified network device. Once the process occurs, the central management system can participate in a secure data tunnel with the network device to send a new password, which is a temporary password. In some implementations, the secure data tunnel may be pre-existing and initiated by the user device. The user device can then receive the temporary password as a secure message and interact with the network device to replace the temporary password with a permanent, user-selected password.

In some implementations, method 700 can be implemented, for example, on a threat management system 101 described with reference to FIG. 1, FIG. 2, FIG. 3, and FIG. 4. In some implementations, some or all of the method 700 can be implemented on one or more client devices, on one or more developer devices, or on one or more server device(s), and/or on a combination of developer device(s), server device(s) and client device(s). In described examples, the implementing system includes one or more digital processors or processing circuitry (“processors”), and one or more storage devices (e.g., a data recorder 304 or other storage). In some implementations, different components of one or more servers and/or clients can perform different blocks or other parts of the method 700. In some examples, a first device is described as performing blocks of method 700. Some implementations can have one or more blocks of method 700 performed by one or more other devices (e.g., other client devices or server devices) that can send results or data to the first device. Method 700 may begin at block 702.

At block 702, credentials are sent to a central management system. These credentials may be sent by a user device. The credentials may be sent to initiate a password reset process for a network device at the central management system. For example, the credentials may include account credentials associated with a user of the network device and an identifier of the network device. For example, the identifier of the network device may be a serial number of the network device. Such a serial number may be automatically obtained from hardware, firmware, software, or a combination thereof of the network device. However, the formation of the secure data tunnel itself may be initiated at the network device.

Other information may be used in lieu of or in addition to a serial number to identify the network device. For example, a Media Access Control (MAC) address, an IP address, a device name, etc., may also be used to identify the network device. The identifier of the network device may also be a serial number (or other identifying information, as discussed herein) that is pre-registered at the central management system. Block 702 may be followed by block 704.

At block 704, a request is sent to a network device to connect to the central management system using a secure data tunnel. For example, the secure data tunnel may be a WebSocket. There may be other secure data tunnel types formed between the network device and the central management system.

In some implementations, the data tunnel may use a virtual private network (VPN) technology. Such VPNs may include Internet Protocol Security (IPsec), OpenVPN, WireGuard, Layer 2 Tunneling Protocol with IPsec (L2TP/IPsec), Secure Socket Tunneling Protocol (SSTP), Secure Shell (SSH) Tunnels, or Point-to-Point Tunneling Protocol (PPTP).

In some implementations, the data tunnel may use, for alternative real-time communication, HTTP long polling, server-sent events (SSE), WebRTC, Message Queuing Telemetry Transport (MQTT), dedicated chat software development kits (SDKs) and application programming interfaces (APIs). As noted, the formation of the secure data tunnel is initiated at the network device.

In some implementations, prior to establishing the secure data tunnel, the network device may perform a reboot operation. After the reboot operation, the network device may establish the secure data tunnel as part of the boot-up process. One aspect of this boot-up process is that the reboot preserves settings of the network and is not a factory reset that returns all (or most) settings of the network device (including login credentials) to factory defaults.

This approach is helpful because the approach permits the login credentials of the network device to be securely reset while avoiding the work that may be involved to restore all (or most) of the other settings. Additionally, if a user of the network device does not know the factory default login credentials (e.g., a sticker with the default password is lost or otherwise unavailable), a factory reset may not suffice to permit the user to access the network device. Block 704 may be followed by block 706. However, other orderings are possible.

At block 706, an acknowledgment that that a secure data tunnel is established is received. Specifically, the acknowledgment indicates that the secure data tunnel is established between the central management system and the network device. Block 706 may be followed by block 708.

At block 708, a password change request is received. Specifically, the password change request may be a password change request for the network received from a user of the user device. Block 708 may be followed by block 710.

At block 710, a request is sent to the central management system for a new password. The new password may be a new password for the network, and the new password may be sent to the network device over the secure data tunnel. The new password may be a temporary password. Block 710 may be followed by block 712.

At block 712, a new password is received as a secure message. For example, the network device may have received the new password from the central management system. The new password may be a temporary password. If the new password is a temporary password, the new password may be associated with an expiry time, and logging the user into the network device is to be performed prior to the expiry time. Once the expiry time lapses, the password process may be re-initiated before the password can be reset.

As another aspect of the new password being a temporary password, the new password may be a one-time password (OTP). If the temporary password is an OTP, the temporary password may permit a single sign-in (before becoming invalid), solely for the purpose of updating the password. In some implementations, when logging in using the temporary password, the network device permits access to an interface to update the password until the password is updated or otherwise limits access. In other implementations, the user can access all functions of the network device, but the user is strongly encouraged to update the temporary password. Block 712 may be followed by block 714.

At block 714, a user of the network device is logged into the network device using the new password. The user device may log the user into the network device using the new password. The network device may enable the user of the user device to set a user-selected password for the user of the network device. In some implementations, the network device has one user account and that user account is the account whose credentials are managed.

In some implementations, the network device has multiple accounts. The account whose credentials are managed may be a selected user account. In some implementations, the selected user account may be an account with administrator privileges, root privileges, and/or superuser privileges. With these privileges, an account user has full access to the system and can perform any system task.

In some implementations, the selected user account may be an account with other privileges. There may be standard users with specific access privileges, or guest users with heavily restricted access. For example, the central management system may permit the user to use the user device to set user privileges of an account at the cloud. User privileges may include basic access rights such as read, write, delete, and execute rights for information at the network device. User privileges may also permit a user to manage other user accounts, manage network resources, install and/or update software, or change system settings.

For example, system settings managed by a user account may include internet protocol (IP addresses), which may be static or dynamic. Related settings may include subnet masks, gateway settings, and domain name system (DNS) features. A user account may also manage firewall settings. Such firewall settings may include rule creation (allowing or blocking traffic based on network characteristics, logging, and security profiles.

A user account may also manage access control. This manages aspects to network resources based on user roles or groups. These settings may include settings to manage user accounts, associated permissions, and network policies. The user account may also manage properties of a wired connection, such as prioritization, turning connections on and off, etc. The user account may also manage properties of a wireless connection, such as Wi-Fi, Bluetooth, etc. A Wi-Fi connection may be associated with settings such as SSID (network name), password (security key), channel selection, network mode, and so on.

In addition to Wi-Fi networks, wireless networks may include Bluetooth, Cellular Networks, Satellite Communication, etc. Cellular networks may include 1G, 2G, 3G, 4G, 5G, and so on, and may use cellular technologies such as Global System for Mobile Communications (GSM), Code Division Multiple Access (CDMA), Long Term Evolution (LTE), and New Radio (NR).

Other wireless technologies may include Near Field Communication (NFC), Zigbee, LoRa, Mesh Networking, Ad-Hoc Networking, Infrared (IR), and wireless networks of various size (Wireless Local Area Network (WLAN), Wireless Personal Area Network (WPAN), Wireless Wide Area Network (WWAN), Wireless Metropolitan Area Network (MAN)). Block 714 may be followed by block 716.

At block 716, the user login credentials are updated. For example, the user login credential may be updated based on the user-selected password. In some implementations, updating the user login credentials may include marking pre-existing user login credentials of the user of the network device as invalid.

FIG. 8 illustrates a flow chart of an example method 800 for secure password reset performed by a network device, in accordance with some implementations. Various secure techniques are used by a network device to secure reset a password for the network device. For example, the network device may establish a connection with a central management system on the cloud and receive a notification of a password reset process from the central management system. Once the notification occurs, the network device can establish a secure data tunnel with the central management system to receive a new password, which is a temporary password. The network device can then send the temporary password as a secure message and interact with the user device to replace the temporary password with a permanent, user-selected password.

In some implementations, method 800 can be implemented, for example, on a threat management system 101 described with reference to FIG. 1, FIG. 2, FIG. 3, and FIG. 4. In some implementations, some or all of the method 800 can be implemented on one or more client devices, on one or more developer devices, or on one or more server device(s), and/or on a combination of developer device(s), server device(s) and client device(s). In described examples, the implementing system includes one or more digital processors or processing circuitry (“processors”), and one or more storage devices (e.g., a data recorder 304 or other storage). In some implementations, different components of one or more servers and/or clients can perform different blocks or other parts of the method 800. In some examples, a first device is described as performing blocks of method 800. Some implementations can have one or more blocks of method 800 performed by one or more other devices (e.g., other client devices or server devices) that can send results or data to the first device. Method 800 may begin at block 802.

At block 802, an identifier of the network device is registered with the central management system. As discussed in the discussion above, the identifier may be a serial number or another appropriate identifier or combination of identifiers, obtained from hardware, software, and/or firmware. Optionally, the network device may be rebooted after being registered with the central management system. The reboot occurs after a user of the user device sends credentials to the central management system to initiate a password reset process for the network device.

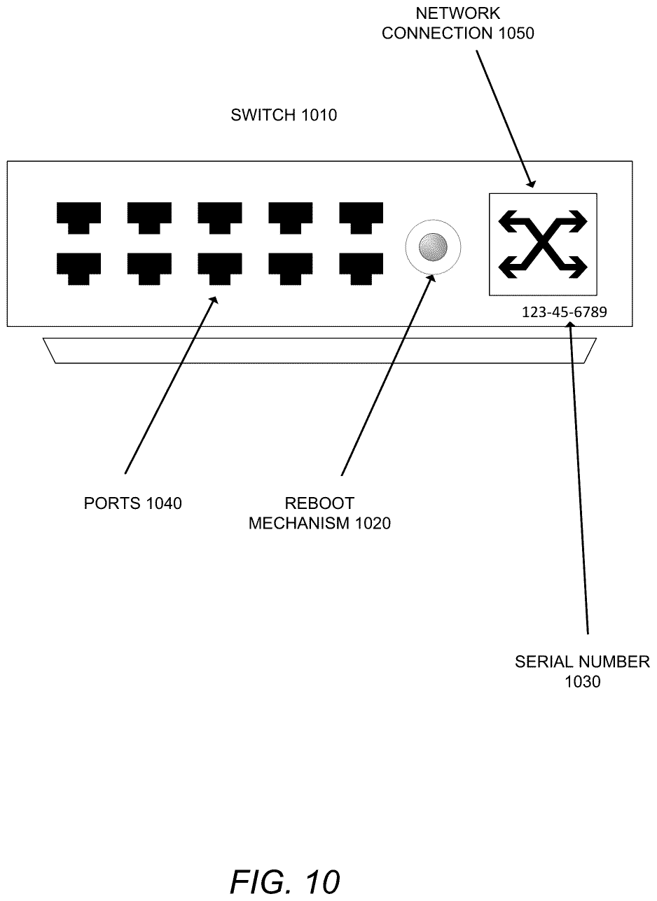

The credentials include account credentials associated with a user of the network device and the identifier of the network device. The settings of the network device are preserved during the reboot operation of the network device, which may be helpful in that the reboot operation prepares the network device for a new, securely reset password while minimizing effort and downtime. As discussed further in the discussion of FIG. 10, the reboot operation of the network device requested via hardware input from a physical button of the network device or from other physical interaction with the network device, via software input, or a combination thereof. Block 802 may be followed by block 804.

At block 804, an authentication token is received. In some implementations, the token may be a JSON Web Token (JWT) Token. In other implementations, other tokens may be used. For example, the token may be an access token, a refresh token, an ID token, a bearer token, an API key, federated token, an OAuth token, an opaque token, or a Basic Auth token. Block 804 may be followed by block 806.

At block 806, a secure data tunnel is formed using the authentication token. As discussed herein, the secure data tunnel may take on a variety of forms. The role of the secure data tunnel is to permit the central management system to securely provide a temporary password to the network device so that the network device may interact with the user device and update the password securely. Block 806 may be followed by block 808.

At block 808, a password change notification is received via the secure data tunnel. For example, the password change notification is received by the network device over the secure data tunnel, and the password change notification is sent in response to the initiation of the password change process by the user device. The new password may be received over the secure data tunnel directly from the central management system or by a secure pull operation from the central management system.

The password change notification includes a new password for use by the network device. The password change notification may also include other information, such as an expiry time for the new password, account information associated with the password, and so on. The password change notification may also mark the password as a one-time password (OTP) or provide other instructions for the password reset process. Block 808 may be followed by block 810.

At block 810, a new password may be sent in a secure message. In some implementations this may include requesting a new password as a secure message as a user device request password from the central management system as a follow up to a password change notification. The secure message provides the new password to the user device to permit the user of the user device to select a new user password. In some implementations, the secure message is secure because the message is encrypted. In some implementations, the secure message is secure because the message technique is secure. In some implementations, both of these apply.

While the new password may be sent as a secure message, other secure ways to provide the user of the user device with access to the new password may apply. For example, the user device may be integrated into the network device in a way that user device and the network device can both access a shared memory and/or a shared data storage and thus can each access the temporary password without separate communication and/or interaction. Block 810 may be followed by block 812.

At block 812, a user-selected password may be received in a secure message. The secure message may be a second secure message. After block 810, the user has selected a new password and the network device receives the user-selected password. The new password may be received as a secure message. The secure message with the new password may use a same messaging approach as that used to send the temporary password or another messaging approach. Also, as noted for block 810, the network device and the user device may be integrated in a way that the network device can directly access the user-selected password once the user provides it. Block 812 may be followed by block 814.

At block 814, user login credentials are updated. Specifically, the network device records the appropriate login credentials (which include the user-selected password as well as any other relevant credentials) in its local settings memory. For example, the network device may associate the user-selected password with an administrator user account on the network device. The updating may replace pre-existing user credentials. For example, the updating may include marking pre-existing user login credentials as invalid.

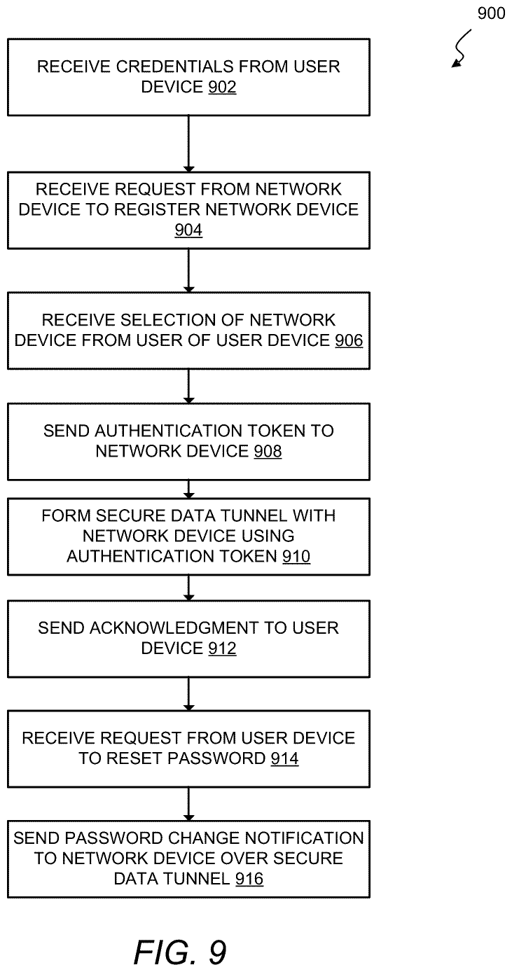

FIG. 9 illustrates a flow chart of an example method 900 for secure password reset performed by a central management system, in accordance with some implementations. Various secure techniques are used by a central management system to secure reset a password for a network device.

For example, the central management system may establish a connection with a central management system on the cloud and initiate a password reset process for a specified network device. Once the process occurs, the central management system can establish a secure data tunnel with the network device to send a new password, which is a temporary password. The user device can then receive the temporary password as a secure message and interact with the network device to replace the temporary password with a permanent, user-selected password.

In some implementations, method 900 can be implemented, for example, on a threat management system 101 described with reference to FIG. 1, FIG. 2, FIG. 3, and FIG. 4. In some implementations, some or all of the method 900 can be implemented on one or more client devices, on one or more developer devices, or on one or more server device(s), and/or on a combination of developer device(s), server device(s) and client device(s). In described examples, the implementing system includes one or more digital processors or processing circuitry (“processors”), and one or more storage devices (e.g., a data recorder 304 or other storage). In some implementations, different components of one or more servers and/or clients can perform different blocks or other parts of the method 900. In some examples, a first device is described as performing blocks of method 900. Some implementations can have one or more blocks of method 900 performed by one or more other devices (e.g., other client devices or server devices) that can send results or data to the first device. Method 900 may begin at block 902.

At block 902, credentials are received from a user device. The credentials may be received by a central management system from a user device to initiate a password reset process for a network device. The credentials may include account credentials associated with a user of the network device and an identifier of the network device.

For example, the account credentials may include a username and password, which authenticate a user of the network device. The identifier of the network device may be a serial number. By providing the account credentials, the user device is provided with access at the central management system to the network device identified by the serial number (or other identifying information). Block 902 may be followed by block 904. A user may authenticate first and add the device to be allowed to connect to the central management system and only after that the device can establish the secure tunnel with the central management system. Without a user adding the device a registration request will keep failing.

At block 904, a request from a network device to register the network device is received. The request may include the identifier of the network device. When the registration occurs, the network device provides its serial number to the central management system. The serial number provides information such that the central management system can form a secure data tunnel with the network device once the network device is selected.

The serial number may be a serial number of the network device automatically obtained from hardware, firmware, software, or a combination thereof of the network device. After receiving the request from the network device to register the network device, the central management system receives an acknowledgement that the network device has performed a reboot operation that preserves settings of the network device. Such a reboot operation may be helpful in that part of the boot-up process may include forming the secure data tunnel. The reboot operation may facilitate resetting the password, but the reboot operation is not a factory reset that loses all (or most) settings and restores a factory default password (which may be unavailable or may be available to a malicious actor). Block 904 may be followed by block 906.

At block 906, a selection of the network device is received from a user of the user device. For example, the central management system may provide web browser access to the central management system. The web browser may be a standard web browser, a mobile browser, or any other web browser (for example, a video game console or another electronic peripheral such as an E-reader may provide a browser).

For example, the central management system may be associated with a specific URL. Such a URL may be translated into an IP address using a Domain Name Server (DNS) server. The central management system may then present a user with a login page to enter central management system account credentials (these may be username and password, but other credentials are possible in addition to or instead of a username and password).

Once logged in the central management system may provide various capabilities, such as role-based access control (RBAC) to manage user permissions, allocating levels of access to users and groups. The central management system may also provide for federated sign-in, allowing access to resources from multiple sources using a single set of credentials. The central management system may also permit users to manage e-mail quarantines and integrate additional cybersecurity products.

The central management system may provide centralized management, real-time security insights, automated threat response, synchronized security (where different security measures share threat information and coordinate their responses), scalability, and API access to manage monitoring, security and administration. The central management system may provide endpoint protection, firewall management, email security, reporting and analytics, user management, device management, threat hunting and response, managed detection and response (MDR), device encryption, and zero trust network access (ZTNA) capabilities. Block 906 may be followed by block 908.

At block 908, an authentication token is sent to the network device. As discussed above, the authentication token may take on a number of different types. In some implementations, the token may be a JSON Web Token (JWT) Token. In other implementations, other tokens may be used. For example, the token may be an access token, a refresh token, an ID token, a bearer token, an API key, federated token, an OAuth token, an opaque token, or a Basic Auth token. Block 908 may be followed by block 910.

At block 910, a secure data tunnel is formed with the network device using the authentication token. In some implementations, the secure data tunnel is a WebSocket. Other technologies may be used to form the secure data tunnel. The secure data tunnel may be formed to provide a secure way to share the temporary password, once the method reaches that stage. Block 910 may be followed by block 912.

At block 912, an acknowledgment is sent to the user device. The acknowledgement may notify the user device that the network device is connected to the central management system. The acknowledgment implies that there is a secure connection between the network device and the central management system, through which a temporary password may be sent securely. Block 912 may be followed by block 914.

At block 914, a request from the user device to reset the password is received. For example, the request may be received from the user of the user device using the web browser interface to reset the password of the network device. Block 914 may be followed by block 916.

At block 916, a password change notification is sent to the network device over a secure data tunnel. The password change notification includes a new password. In some implementations, the new password is a temporary password. When sending the new password, in some implementations, the central management system sends the new password directly to the network device over the secure data tunnel. In some implementations, the central management system sends the new password to the network device in response to a pull request for the network device.

The new password may be associated with an administrator user account on the network device. The new password may be set to expire after a predetermined time interval passes. The time interval may be a constant time interval or may be a time interval that a user may set at the central management system.

The new password is used to update user login credentials of the network device by sending the new password to the user device as a secure message to update user login credentials of the network device based on a user-selected password. As part of the updating, pre-existing user login credentials of the network device are marked invalid.

FIG. 10 illustrates a switch 1010, in accordance with some implementations. In some embodiments, switch 1010 may be implemented as and/or using one or more of the devices illustrated in FIG. 1 and/or FIG. 2 within the enterprise facility 102. For example, switch 1010 may be implemented as and/or using a firewall 10, a wireless access point 11, an endpoint, a server 114, a mobile device 16, an IoT device 18, a cloud computing instance 19, and/or a server 20. Switch 1010 may also be implemented as and/or using endpoint 22 and/or mobile device 26. Such a switch 1010 may include various components contained within an appropriate chassis. The chassis may contain a switch fabric for data forwarding, a central processing unit (CPU) for processing, and power supplies. For example, the switch fabric may include hardware and software that ensure that data entering into the network is sent out via the correct port. There may be a CPU (i.e., a controller) that controls the switching functions. There may also be a buffer, which is a memory that prevents clogging and loss of packets in the network.

FIG. 10 illustrates a reboot mechanism 1020 for switch 1010. The reboot mechanism 1020 is illustrated as a pressable button in FIG. 10. The reboot mechanism 1020 may take on various forms. For example, the button may be a protruding button or a recessed button. The button may be a button that is pressable with a user's finger or may be a button that involves a small object to be depressed (e.g., a paper clip, a toothpick, a safety pin, or a needle).

The button may receive a brief depression (e.g., 1 second or less) or may be pressed and held for a longer interval (such as 5-10 seconds). The reboot mechanism 1020 may cause the switch 1010 to power off and then power on again. An alternative mechanism to reboot the switch is to power the switch 1010 on and off (which may use a power switch or unplugging and replugging a power source).

It is also possible to send a reboot request using software. Given that the user of the switch 1010 may not have access to the web interface for the switch 1010 (the user may lack the requisite password), it is necessary to configure the switch 1010 to accept a software request in a different manner.

With respect to the reboot mechanism 1020, in some implementations, the reboot performed is specifically a reboot rather than a reset. For example, a brief depression of the reboot mechanism 1020 may be a reboot (which merely turns the router off and then on again without changing settings) as opposed to a reset, which refers to a factory reset. In a reboot, the switch 1010 turns off, turns on again, and then loads stored settings without changing settings. It may be helpful to build in a reboot process in that the boot-up process may include forming an appropriate secure data tunnel with the central management server.

FIG. 10 also illustrates that switch 1010 includes a serial number 1030. FIG. 10 illustrates an example serial number 1030 of “123-45-6789”. Other information may be used in lieu of or in addition to a serial number 1030 to identify the switch 1010 (or another network device). For example, a Media Access Control (MAC) address, an IP address, a device name, etc., may also be used to identify the network device.

The identifier of the switch 1010 may also be a serial number (or other identifying information, as discussed) that is pre-registered at the central management server. While FIG. 10 illustrates serial number 1030 as being printed on switch 1010, serial number 1030 need not be printed at all; the serial number 1030 merely needs to be stored in hardware, firmware, software, or a combination thereof for the switch 1010 so that the switch 1010 can use to register with and connect to the central management system.

FIG. 10 also illustrates other aspects of switch 1010, including ports 1040 and network connection 1050. For example, ports 1040 may include input ports and output ports, uplink ports, Ethernet ports (e.g., RJ-45 ports for Ethernet cables). There may also be a network connection 1050. Such a network connection may also be an Ethernet connection or a Small Form-Factor Pluggable (SFP)/Quad Small Form-Factor Pluggable (QSFP) module (which are pluggable modules that connect the switch to a physical medium such as fiber optic cables). The network connection 1050 may connect switch 1010 to a router, such that the router connects switch 1010 to the Internet or another Wide Area Network (WAN).

As noted, switch 1010 may also be replaced or integrated with another network device or combination of devices, such as a router, a hub, a bridge, a repeater, a modem, a gateway, a network interface card (NIC), load balancer, or a device that integrates combinations of these functions into a single device. While switch 1010 illustrates components that are relevant to a switch 1010, include reboot mechanism 1020, serial number 1030, ports 1040, and network connection 1050, if switch 1010 is replaced or combined with a router, a hub, a bridge, a repeater, a modem, a gateway, a network interface card (NIC), load balancer, or a device that integrates combinations of these functions into a single device, there may be more components. Such components may also be implemented as and/or using various components shown in FIGS. 1-2, as discussed above.

For example, a router might also include Random Access Memory (RAM) that stores routing tables and configuration files, Flash Memory, Read-Only Memory (ROM), and/or Non-Volatile RAM (NVRAM) (that stores the router's operating system, boot-up instructions, and startup configuration file), network interfaces (Ethernet ports, Wi-Fi antennas) that connect the router to a network (e.g., the Internet, a Local Area Network (LAN), etc.). There may also be a bus connecting various components. Other network components may include other parts suitable for their respective functions.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the implementations can be described above primarily with reference to user interfaces and particular hardware. However, the implementations can apply to any type of computing device that can receive data and commands, and any peripheral devices providing services.

Reference in the specification to “some implementations” or “some instances” means that a particular feature, structure, or characteristic described in connection with the implementations or instances can be included in at least one implementation of the description. The appearances of the phrase “in some implementations” in various places in the specification are not necessarily all referring to the same implementations.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The implementations of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware implementations, some entirely software implementations or some implementations containing both hardware and software elements. In some implementations, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be implemented in systems that perform the steps thereof and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Implementations disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be implemented in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity and need not be located within a particular jurisdiction.

It will be appreciated that the methods and systems described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular implementations have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A computer-implemented method, the method comprising:
sending credentials to a central management system to initiate a password reset process for a network device at the central management system, wherein the credentials comprise account credentials associated with a user of the network device and an identifier of the network device;
sending a request to the network device to cause the network device to connect to the central management system using a secure data tunnel;
receiving an acknowledgement from the central management system that the secure data tunnel is established between the central management system and the network device;
receiving a password change request for the network device from a user of a user device;
sending a request to the central management system for a new password for the network device to be sent to the network device over the secure data tunnel, wherein the new password is a temporary password;
receiving the new password from the network device as a secure message;
logging the user of the network device into the network device using the new password, wherein the network device enables the user of the user device to set a user-selected password for the user of the network device; and
updating user login credentials of the user of the network device based on the user-selected password, wherein pre-existing user login credentials of the user of the network device are marked invalid.

2. The method of claim 1, wherein the identifier of the network device is a serial number of the network device automatically obtained from hardware, firmware, software, or a combination thereof of the network device.

3. The method of claim 1, wherein the identifier of the network device is a serial number of the network device that is pre-registered at the central management system.

4. The method of claim 1, wherein the network device performs a reboot operation prior to connecting to the central management system using the secure data tunnel, wherein the reboot operation of the network device preserves settings of the network device.

5. The method of claim 1, wherein the secure data tunnel is a WebSocket channel.

6. The method of claim 1, wherein the new password for the network device is associated with an expiry time, and wherein logging the user of the network device into the network device using the new password is performed prior to the expiry time.

7. The method of claim 1, wherein the user-selected password is associated with an administrator user account on the network device.

8. A computer-implemented method, the method comprising:
registering an identifier of a network device with a central management system;
receiving an authentication token from the central management system;
forming a secure data tunnel with the central management system using the authentication token;
receiving a password change notification from the central management system via the secure data tunnel, wherein the password change notification includes a new password, wherein the new password is a temporary password;
sending the new password to a user device in a secure message;
receiving a user-selected password for the network device from the user device in a second secure message; and
updating user login credentials of the network device based on the user-selected password, wherein the updating includes marking pre-existing user login credentials as invalid.

9. The method of claim 8, wherein the identifier of the network device is a serial number of the network device.

10. The method of claim 8, wherein the user-selected password is associated with an administrator user account on the network device.

11. The method of claim 8, wherein a reboot operation of the network device is performed after a user of the user device sends credentials to the central management system to initiate a password reset process for the network device, and wherein the credentials comprise account credentials associated with a user of the network device and the identifier of the network device.

12. The method of claim 11, wherein settings of the network device are preserved during the reboot operation of the network device.

13. The method of claim 11, wherein the reboot operation of the network device is requested via hardware input from a physical button of the network device or from other physical interaction with the network device, via software input, or a combination thereof.

14. The method of claim 8, wherein the new password is received over the secure data tunnel directly from the central management system or by a secure pull operation from the central management system.

15. A computer-implemented method, the method comprising:
receiving credentials from a user device to initiate a password reset process for a network device, wherein the credentials comprise account credentials associated with a user of the network device and an identifier of the network device;
receiving a request from the network device to register the network device, the request comprising the identifier of the network device;
receiving a selection of the network device from a user of the user device;
sending an authentication token to the network device;
forming a secure data tunnel with the network device using the authentication token;
sending an acknowledgment to the user device that the network device has connected to a central management system;
receiving a request from the user device to reset a password of the network device;
sending a password change notification to the network device over the secure data tunnel, wherein the password change notification includes a new password, wherein the new password is a temporary password, the new password is used to update user login credentials of the network device by sending the new password to the user device as a secure message to update user login credentials of the network device based on a user-selected password, and wherein pre-existing user login credentials of the network device are marked invalid.

16. The method of claim 15, wherein the central management system sends the new password directly to the network device over the secure data tunnel or in response to a pull request from the network device.

17. The method of claim 15, wherein the new password is associated with an administrator user account on the network device.

18. The method of claim 15, wherein the new password is set to expire after a predetermined time interval passes.

19. The method of claim 15, wherein, after receiving the request from the network device to register the network device, the central management system receives an acknowledgement that the network device has performed a reboot operation that preserves settings of the network device.

20. The method of claim 15, wherein the identifier of the network device is a serial number of the network device automatically obtained from hardware, firmware, software, or a combination thereof of the network device.
